(19) United States
(12) Patent Application Publication
(10) Pub. No.: US 2026/0308189 A1
(43) Pub. Date: Oct. 8, 2026

(54) METHOD FOR PREPARING H3-ALLYLPALLADIUM(II) HALIDE DIMER THAT IS UNSUBSTITUTED OR HYDROCARBYL-SUBSTITUTED AT ITS H3-ALLYL GROUPS

(71) Applicant: HERAEUS PRECIOUS METALS GMBH & CO. KG., Hanau (DE)

(72) Inventors: Michael UNKRIG-BAU, Hanau (DE); Michael GOCK, Hanau (DE); Ellen HAWLITZKY, Hanau (DE)

(21) Appl. No.: 19/578,281

(22) Filed: Mar. 25, 2026

(30) Foreign Application Priority Data
Apr. 2, 2025 (EP) 25167963.5

(51) Int. Cl. C07F 15/00

(52) U.S. Cl. CPC C07F 15/006

(57) ABSTRACT

A method for preparing [(η³—CR1R2-CR3-CHR4)PdX]₂ by reaction of HₐNa_{b}K_{c}(NH₄)_{d}PdX₄ with CR1R2=CR3-CHR4-Si(R5)₃, where a+b+c+d=2, where H, Na, K and (NH₄) represent hydrogen, sodium, potassium and ammonium, where X represents bromine (Br) or chlorine (Cl), wherein (i) the substituent groups R1 and R2 are selected, independently of one another, from hydrogen (H), phenyl, methyl, ethyl, n-propyl, isopropyl and the isomeric non-cyclic butyl substituent groups, provided that the substituent groups R1 and R2 are not both phenyl, the substituent groups R3 and R4 are selected, independently of one another, from H, methyl, ethyl and n-propyl, and the substituent groups R5 are methyl or ethyl, or wherein (ii) by means of one of the substituent groups R1 or R2, —CR1R2- together with —CR3- form adjacent ring members of a carbocyclic ring system bonded as a substituent to the —CHR4-carbon.

### CROSS-REFERENCE TO RELATED APPLICATION

This application claims priority pursuant to 35 U.S.C. 119(a) to European Patent Application No. 25167963.5, filed Apr. 2, 2025, which application is incorporated herein by reference in its entirety.

### FIELD OF THE INVENTION

The invention relates to a method for preparing l³-allylpalladium(II) halide dimer that is unsubstituted or hydrocarbyl-substituted at its l³-allyl groups.

### BACKGROUND

The term “hydrocarbyl-substituted” used herein means “substituted with one or more hydrocarbon substituent groups, each free of heteroatoms”. In the case of a plurality of such substituents, these can jointly form cyclic and heteroatom-free hydrocarbon structures (carbocyclic structures). The hydrocarbon substituent(s) or carbocycle(s) can be saturated or olefinic and/or aromatically unsaturated.

η³-allylpalladium(II) chloride dimer with the formula [(η³—C₃H₅)PdCl]₂ or [Pd(η³-allyl)Cl]₂ is an important homogeneous catalyst for organic synthesis, for example in cross-coupling reactions. η³-allylpalladium(II) chloride dimer can also be used as a starting material for the synthesis of other highly specialized palladium catalysts.

Various preparation methods for η³-allylpalladium(II) chloride dimers are known.

For example, S. Ogoshi et al., disclose in Organometallics 1993, 12, 578-579, the preparation of [(η³—C₃H₅)PdCl]₂ from Pd(CH₃CN)₂Cl₂ and allyltrimethylsilane in acetonitrile according to the formula:

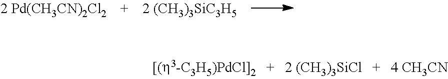

Pd(CH₃CN)₂Cl₂ is an expensive starting material; it can be prepared starting from H₂PdCl₄ via the step sequence H₂PdCl₄→PdCl₂→Pd(CH₃CN)₂Cl₂. The preparation of [(η³—C₃H₅)PdCl]₂ takes place in organic solution, specifically in acetonitrile, which is also formed during the reaction. At 0.2 mol/L Pd, the concentration of the reaction mixture is low in acetonitrile, which makes the process uneconomical. The obtained reaction product [(η³—C₃H₅)PdCl]₂ accumulates in impure form due to the synthesis process, the reaction is incomplete, or a complex of the type Pd(η³-allyl)(CH₃CN)Cl is formed as a byproduct. For use as a homogeneous catalyst, the highest possible product purity is desirable.

Furthermore, for example in Synt. React. Inorg. Met.-Org. Chem. 1992, 22(9), 1395-1399, R. C. Palenik and G. J. Palenik disclose the preparation of [(η³—C₃H₅)PdCl]₂ from potassium tetrachloropalladate and allyl chloride in the presence of water according to the formula:

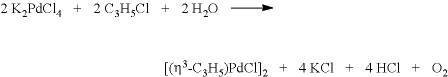

Allyl chloride is highly toxic and handling it therefore poses a significant danger. The reaction time for this reaction is very long, at 16 to 24 hours. The concentration of the reaction mixture is low, at 0.18 mol/L Pd in water, which makes the process uneconomical.

Furthermore, for example International Application 2022/136,049 mentions the preparation of [(η³—C₃H₅)PdCl]₂ starting from [Pd₂(dvds)₃] and allyl chloride; “dvds” stands, in this case, for 1,3-divinyl-1,1,3,3-tetramethyldisiloxane. [Pd₂(dvds)₃] is complex to prepare and is sensitive to air. As already mentioned, allyl chloride is highly toxic and handling it therefore poses a significant danger.

### SUMMARY

The object of the invention is to provide an improved preparation method for [(η³—C₃H₅)PdX]₂ or for derivatives of [(η³—C₃H₅)PdX]₂ that are hydrocarbyl-substituted at the η³-allyl groups, which method avoids the aforementioned disadvantages of the prior art. The letter “X” used in formula [(η³—C₃H₅)PdX]₂ stands for the halogens bromine and chlorine respectively.

Surprisingly, the object is achieved by reacting tetrabromo- or tetrachloropalladium acid and/or at least one salt derived therefrom with allyltrimethyl or allyltriethylsilane that is unsubstituted or substituted at the allyl group. Specifically, the invention relates to a method for preparing [(η³—CR1R2-CR3-CHR4)PdX]₂ by reaction of HₐNa_{b}K_{c}(NH₄)_{d}PdX₄ with CR1R2=CR3-CHR4-Si(R5)₃, where a+b+c+d=2, where H, Na, K and (NH₄) represent hydrogen, sodium, potassium and ammonium, where X represents bromine (Br) or preferably chlorine (Cl), wherein (i) the substituent groups R1 and R2 are selected, independently of one another, from hydrogen (H), phenyl, methyl, ethyl, n-propyl, isopropyl and the isomeric non-cyclic butyl substituent groups, provided that the substituent groups R1 and R2 are not both phenyl, the substituent groups R3 and R4 are selected, independently of one another, from H, methyl, ethyl and n-propyl, and the substituent groups R5 are methyl or ethyl, or wherein (ii) by means of one of the substituent groups R1 or R2, —CR1R2- together with —CR3- form adjacent ring members of a carbocyclic ring system bonded as a substituent to the —CHR4-carbon, the substituent group R2 or R1 which is not involved in the formation of the carbocyclic ring system is selected from H, phenyl, methyl, ethyl, n-propyl, isopropyl and the isomeric non-cyclic butyl substituent groups, the substituent group R4 is selected from H, methyl, ethyl and n-propyl, and the substituent groups R5 are methyl or ethyl.

This method is summarized as a method for preparing [(η³—CR1R2-CR3-CHR4)PdX]₂ by reaction of HₐNa_{b}K_{c}(NH₄)dPdX₄ with CR1R2=CR3-CHR4-Si(R5)₃, where a+b+c+d=2, where H, Na, K and (NH₄) represent hydrogen, sodium, potassium and ammonium, where X represents bromine (Br) or chlorine (Cl), wherein (i) the substituent groups R1 and R2 are selected, independently of one another, from hydrogen (H), phenyl, methyl, ethyl, n-propyl, isopropyl and the isomeric non-cyclic butyl substituent groups, provided that the substituent groups R1 and R2 are not both phenyl, the substituent groups R3 and R4 are selected, independently of one another, from H, methyl, ethyl and n-propyl, and the substituent groups R5 are methyl or ethyl, or wherein (ii) by means of one of the substituent groups R1 or R2, —CR1R2- together with —CR3- form adjacent ring members of a carbocyclic ring system bonded as a substituent to the —CHR4-carbon, the substituent group R2 or R1 which is not involved in the formation of the carbocyclic ring system is selected from H, phenyl, methyl, ethyl, n-propyl, isopropyl and the isomeric non-cyclic butyl substituent groups, the substituent group R4 is selected from H, methyl, ethyl and n-propyl, and the substituent groups R5 are methyl or ethyl.

In section (ii) of the preceding paragraph, the term “carbocyclic ring system” is used. The carbocyclic ring system represents a substituent on the —CHR4 carbon.

Preferably, the substituent group R4 is H, i.e., preferably the —CHR4 group is —CH₂—.

The method according to the invention comprises the steps of:
(1) providing HₐNa_{b}K_{c}(NH₄)dPdX₄ and CR1R2=CR3-CHR4-Si(R5)₃, and,
(2) bringing the two reactants provided in step (1), HₐNa_{b}K_{c}(NH₄)dPdX₄ and CR1R2=CR3-CHR4-Si(R5)₃, into contact in a reaction vessel, and allowing them to react, forming [(η³—CR1R2-CR3-CHR4)PdX]₂, wherein at least one of the two reactants, HₐNa_{b}K_{c}(NH₄)dPdX₄ and CR1R2=CR3-CHR4-Si(R5)₃, has previously been converted into a preparation containing at least one organic solvent and optionally water.

In step (1) of the preferred embodiment of the method according to the invention, the already mentioned starting materials HₐNa_{b}K_{c}(NH₄)dPdX₄ and CR1R2=CR3-CHR4-Si(R5)₃ are provided.

As mentioned above, the formula HₐNa_{b}K_{c}(NH₄)dPdX₄, used repeatedly herein, stands for HₐNa_{b}K_{c}(NH₄)_{d}PdBr₄ or preferably for HₐNa_{b}K_{c}(NH₄)_{d}PdCl₄, where in each case a+b+c+d=2, i.e., the indices a, b, c and d can take any values in the range from 0 to 2, the crucial point is that the condition a+b+c+d=2 is satisfied. The following four variants are preferred:
HₐNa_{b}K_{c}(NH₄)_{d}PdX₄ with a=2 and b=c=d=0, i.e., H₂PdX₄
HₐNa_{b}K_{c}(NH₄)_{d}PdX₄ with b=2 and a=c=d=0, i.e., Na₂PdX₄
HₐNa_{b}K_{c}(NH₄)_{d}PdX₄ with c=2 and a=b=d=0, i.e., K₂PdX₄
HₐNa_{b}K_{c}(NH₄)_{d}PdX₄ with d=2 and a=b=c=0, i.e., (NH₄)₂PdX₄.

The variant H₂PdX₄ is particularly preferred.

All variants of HₐNa_{b}K_{c}(NH₄)_{d}PdX₄ are easily accessible; they are either commercially available or can be easily prepared by a person skilled in the art.

The preferred compound H₂PdX₄ with X=Br or preferably with X=Cl can be prepared by reacting palladium with X₂ and HX or by reaction of PdX₂ with HX; HX stands, in this case, for hydrobromic acid or preferably for hydrochloric acid. H₂PdX₄ therefore stands for tetrabromo palladium acid (H₂PdBr₄) or preferably for tetrachloropalladium acid (H₂PdCl₄), in each case as an aqueous solution. Tetrachloropalladium acid is commercially available for example from Heraeus, in the form of aqueous solutions with different palladium weight fractions, in stages of 5.5 wt. %, 10 wt. %, 15 wt. %, 18 wt. %, 20 wt. % and 22 wt. %.

The salts Na₂PdX₄, K₂PdX₄ and (NH₄)₂PdX₄, in each case with X=Br or preferably with X=Cl, are either commercially available (for example from Heraeus) or can be prepared by neutralizing H₂PdX₄ with the corresponding bases, for example in the form of corresponding oxides, hydroxides, carbonates. In order to obtain the salts, the aqueous salt solutions can then be evaporated. As an alternative to preparation by neutralization, it is also possible to dissolve PdX₂ in water using NaX, KX or NH₄X, forming the corresponding salts.

The preparation of mixed salts (both mixed neutral salts and mixed acidic salts) is achieved in a completely analogous way in the course of a corresponding neutralization reaction as mentioned above, or also as mentioned above starting from PdX₂. Examples of mixed salts obtainable in this way include:
HₐNa_{b}K_{c}(NH₄)_{d}PdX₄ with c=d=0 and a+b=2, i.e., HₐNa_{b}PdX₄,
HₐNa_{b}K_{c}(NH₄)_{d}PdX₄ with b=d=0 and a+c=2, i.e., HₐK_{c}PdX₄,
HₐNa_{b}K_{c}(NH₄)_{d}PdX₄ with b=c=0 and a+d=2, i.e., Hₐ(NH₄)_{d}PdX₄,
HₐNa_{b}K_{c}(NH₄)_{d}PdX₄ with a=d=0 and b+c=2, i.e., Na_{b}K_{c}PdX₄,
HₐNa_{b}K_{c}(NH₄)_{d}PdX₄ with a=c=0 and b+d=2, i.e., Na_{b}(NH₄)_{d}PdX₄,
HₐNa_{b}K_{c}(NH₄)_{d}PdX₄ with a=b=0 and c+d=2, i.e., K_{c}(NH₄)_{d}PdX₄,
HₐNa_{b}K_{c}(NH₄)_{d}PdX₄ with d=0 and a+b+c=2, i.e., HₐNa_{b}K_{c}PdX₄,
HₐNa_{b}K_{c}(NH₄)_{d}PdX₄ with c=0 and a+b+d=2, i.e., HₐNa_{b}(NH₄)_{d}PdX₄,
HₐNa_{b}K_{c}(NH₄)_{d}PdX₄ with b=0 and a+c+d=2, i.e., HₐK_{c}(NH₄)_{d}PdX₄,
HₐNa_{b}K_{c}(NH₄)_{d}PdX₄ with a=0 and b+c+d=2, i.e., Na_{b}K_{c}(NH₄)_{d}PdX₄, and
HₐNa_{b}K_{c}(NH₄)_{d}PdX₄ with a+b+c+d=2.

The three identical substituent groups R5 of the silanes of the general formula CR1R2=CR3-CHR4-Si(R5)₃ are methyl or ethyl groups, preferably methyl groups; corresponding example compounds include the following seven representatives:

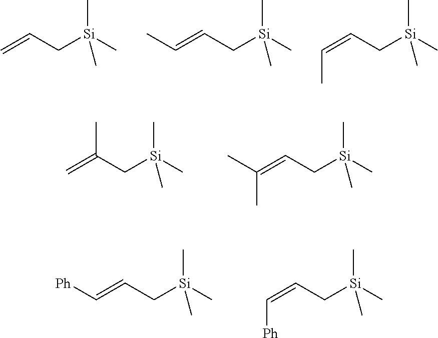

In the simplest and particularly preferred case, CR1R2=CR3-CHR4-Si(R5)₃ is allyltrimethylsilane (i.e., R1=R2=R3=R4=H and R5=methyl). Allyltrimethylsilane is commercially available, for example from Merck; it can be prepared by reacting allyltrichlorosilane with the Grignard reagent methylmagnesium bromide, as described, for example, in Example 2 of U.S. Pat. No. 3,125,554. Starting from the corresponding allyltrichlorosilanes of the formula CR1R2=CR3-CHR4-SiCl₃, the silanes that are substituted at their allyl group and have the formula CR1R2=CR3-CHR4-Si(R5)₃ can also be prepared by reaction with the Grignard reagent methylmagnesium bromide.

In step (2) of the method according to the invention, the starting materials provided in step (1) or the two reactants HₐNa_{b}K(NH₄)_{d}PdX₄ and CR1R2=CR3-CHR4-Si(R5)₃ are brought into contact with each other in a reaction vessel and allowed to react to form [(η³—CR1R2-CR3-CHR4)PdX]₂, wherein at least one of the two reactants HₐNa_{b}K_{c}(NH₄)_{d}PdX₄ and CR1R2=CR3-CHR4-Si(R5)₃ has previously been converted into a preparation containing at least one organic solvent and, optionally, water. Method step (2) can therefore be broken down into two sub-steps (2a) and (2b).

The at least one organic solvent is not subject to any fundamental restrictions regarding the classes of substances from which it can be selected; however, it should expediently not comprise methanol or acetone. Preferably, the at least one organic solvent has a relatively low boiling point, for example not above 150° C. The at least one organic solvent can be selected, for example, from alcohols (expediently not methanol), ethers, esters, lactones, chlorinated hydrocarbons, ketones (expediently not acetone), sulfoxides, amides, carbonates, and aromatic hydrocarbons. Preferably, the solvent is at least one organic solvent selected from alcohols with two to ten carbon atoms, for example ethanol or, in particular, isopropanol.

In sub-step (2a), at least one of the two starting materials and reactants HₐNa_{b}K_{c}(NH₄)_{d}Pd₄ and CR1R2=CR3-CHR4-Si(R5)₃ is previously converted into a preparation containing at least one organic solvent and optionally water. In sub-step (2b), one reactant, as a preparation or as such, is then added to the other reactant, as such or as a preparation, already present in the reaction vessel, and allowed to react, forming [(η³—CR1R2-CR3-CHR4)PdX]₂. In this case, the following cases are possible and must be distinguished:
1. Provision of HₐNa_{b}K_{c}(NH₄)_{d}PdX₄ salt as a preparation containing water and at least one organic solvent, addition of CR1R2=CR3-CHR4-Si(R5)₃ as such;
2. Provision of HₐNa_{b}K_{c}(NH₄)_{d}PdX₄ salt as a preparation containing water and no organic solvent, addition of CR1R2=CR3-CHR4-Si(R5)₃, as a preparation in at least one organic solvent;
3. Provision of HₐNa_{b}K_{c}(NH₄)_{d}PdX₄ salt as a preparation containing water and at least one organic solvent, addition of CR1R2=CR3-CHR4-Si(R5)₃ as a preparation in at least one organic solvent;
4. Provision of H₂PdX₄ as a preparation containing water and at least one organic solvent, addition of CR1R2=CR3-CHR4-Si(R5)₃ as such;
5. Provision of H₂PdX₄ as a preparation containing water and no organic solvent, addition of CR1R2=CR3-CHR4-Si(R5)₃ as a preparation in at least one organic solvent;
6. Provision of H₂PdX₄ as a preparation containing water and at least one organic solvent, addition of CR1R2=CR3-CHR4-Si(R5)₃ as a preparation in at least one organic solvent;
7. Provision of HₐNa_{b}K_{c}(NH₄)_{d}PdX₄ salt as a preparation in at least one organic solvent, addition of CR1R2=CR3-CHR4-Si(R5)₃ as such;
8. Provision of HₐNa_{b}K_{c}(NH₄)_{d}PdX₄ salt as such, addition of CR1R2=CR3-CHR4-Si(R5)₃ as a preparation in at least one organic solvent;
9. Provision of HₐNa_{b}K_{c}(NH₄)_{d}PdX₄ salt as a preparation in at least one organic solvent, addition of CR1R2=CR3-CHR4-Si(R5)₃ as a preparation in at least one organic solvent;
10. Provision of CR1R2=CR3-CHR4-Si(R5)₃ as such, addition of HₐNa_{b}K_{c}(NH₄)_{d}PdX₄ salt as a preparation containing water and at least one organic solvent;
11. Provision of CR1R2=CR3-CHR4-Si(R5)₃ as a preparation in at least one organic solvent, addition of HₐNa_{b}K_{c}(NH₄)_{d}PdX₄ salt as a preparation containing water and no organic solvent;
12. Provision of CR1R2=CR3-CHR4-Si(R5)₃ as a preparation in at least one organic solvent, addition of HₐNa_{b}K_{c}(NH₄)_{d}PdX₄ salt as a preparation containing water and at least one organic solvent;
13. Provision of CR1R2=CR3-CHR4-Si(R5)₃ as such, addition of HₐNa_{b}K_{c}(NH₄)_{d}PdX₄ salt as a preparation in at least one organic solvent;
14. Provision of CR1R2=CR3-CHR4-Si(R5)₃ as a preparation in at least one organic solvent, addition of HₐNa_{b}K_{c}(NH₄)_{d}PdX₄ salt as such;
15. Provision of CR1R2=CR3-CHR4-Si(R5)₃ as a preparation in at least one organic solvent, addition of HₐNa_{b}K_{c}(NH₄)_{d}PdX₄ salt as a preparation in at least one organic solvent;
16. Provision of CR1R2=CR3-CHR4-Si(R5)₃ as such, addition of H₂PdX₄ as a preparation containing water and at least one organic solvent;
17. Provision of CR1R2=CR3-CHR4-Si(R5)₃ as a preparation in at least one organic solvent, addition of H₂PdX₄ as a preparation containing water and no organic solvent; and,
18. Provision of CR1R2=CR3-CHR4-Si(R5)₃ as a preparation in at least one organic solvent, addition of H₂PdX₄ as a preparation containing water and at least one organic solvent.

Cases 1 to 6, and in particular 4 to 6, are preferred cases.

The preparations of CR1R2=CR3-CHR4-Si(R5)₃ in at least one organic solvent are solutions.

The preparations of HₐNa_{b}K_{c}(NH₄)_{d}PdX₄ salt or of H₂PdX₄ may be, for example, solutions or suspensions, depending on the nature of the substances combined therein. The palladium content of such preparations can be, for example, in the range of 0.5 to 4 mol/L, preferably 0.8 to 1.6 mol/L preparation. In the case of preparations containing water as well as at least one organic solvent, the weight ratio of water to the at least one organic solvent may, for example, be in the range of 10:1 to 1:10.

In sub-step (2b), one reactant, either as a preparation or as such, is then added to the other reactant, as such or as a preparation, which is already present in the reaction vessel, and allowed to react, forming [(η³—CR1R2-CR3-CHR4)PdX]₂.

Upon contact of the H₂PdX₄ or of the HₐN/a_{b}K_{c}(NH₄)_{d}PdX₄ salt and the CR1R2=CR3-CHR4-Si(R5)₃ an exothermic reaction occurs, forming [(η³—CR1R2-CR3-CHR4)PdX]₂ according to the formula:

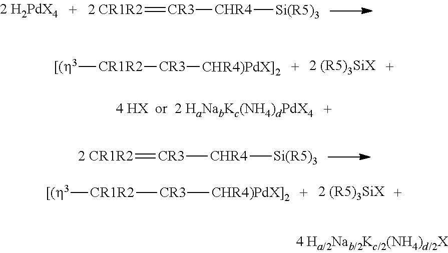

After the addition has taken place and also afterwards, it is expediently mixed thoroughly, in particular by stirring; thorough mixing is particularly important in the case of a two-phase or multi-phase reaction mixture. The addition is carried out, for example, in a molar ratio of 1 to 1.5 mol CR1R2=CR3-CHR4-Si(R5)₃: 1 mol Pd; in this case, if CR1R2=CR3-CHR4-Si(R5)₃ represents the reactant to be added, it is possible to proceed for example in such a way that the addition of the CR1R2=CR3-CHR4-Si(R5)₃ takes place first, until a 1:1 molar ratio is reached, and then a reaction within the mixture is allowed to subside before further CR1R2=CR3-CHR4-Si(R5)₃ is optionally added.

Given the aforementioned exothermicity, it is expedient to take measures, during the contacting of the two reactants, to prevent the temperature of the reaction mixture forming or already formed in the reaction vessel from rising above 50° C.; examples of said measures include common internal and/or external cooling measures. Preferably, the temperature in the reaction mixture can be kept, for example, in the range of 20 to 40° C. In addition to corresponding cooling measures during the addition of one reactant to the other reactant, and during the ongoing reaction, it may be expedient to first cool the provided component to a temperature for example in the range of 5 to 10° C. and only then begin adding one reactant to the other reactant. As soon as no more exothermic activity is observed, the reaction is complete and the formed reaction product [(η³—CR1R2-CR3-CHR4)PdX]₂ can often be separated as a solid using solid-liquid separation methods; examples of common solid-liquid separation methods include decanting, filtration, and centrifugation. Needless to say for a person skilled in the art, the possibility of separating the [(η³—CR1R2-CR3-CHR4)PdX]₂ as a solid may be dependent on the CR1R2=CR3-CHR4-Si(R5)₃ used and/or for example on the selected at least one organic solvent. Optionally, after concentration or complete evaporation of the composition, which is solid-free or freed of solids, solid [(η³—CR1R2-CR3-CHR4)PdX]₂ or further solid [(η³—CR1R2-CR3-CHR4)PdX]₂ are obtained. The concentration or evaporation can be done at reduced pressure. It is expedient not to exceed a temperature of 40° C. during concentration or evaporation. The obtained [(η³—CR1R2-CR3-CHR4)PdX]₂ solid can then be washed and dried; for example, washing can be carried out in the usual way on a Buchner funnel, for example with alcohol as the washing liquid, possibly followed by washing with petroleum benzine. If the [(η³—CR1R2-CR3-CHR4)PdX]₂ solid contains a water-soluble impurity, it may be expedient to perform a washing step with water before washing with organic solvent. Drying until mass consistency is achieved can follow, at reduced pressure and a temperature expediently not exceeding 40° C.

The method according to the invention allows the preparation of [(η³-CR1R2-CR3-CHR4)PdX]₂ with yields generally >90% at product purity levels of generally ≥97%.

### EXAMPLES

All reactions were carried out in conventional laboratory glassware. All chemicals were commercially available and were used without further purification.

¹H-NMR spectra were recorded on a Bruker Avance 400 spectrometer and evaluated using Bruker's Topspin software.

### Exemplary Embodiment 1a (Representation of η³-allylpalladium(II) Chloride Dimer, [(η³—C₃H₅)PdCl]₂)

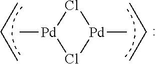

while stirring, 231 g of an aqueous H₂PdCl₄ solution with a Pd content of 20 wt. % were mixed with 231 mL of isopropanol. 53 g of allyltrimethylsilane were added dropwise under ice cooling. After the exothermic reaction had subsided, another 10 g of allyltrimethylsilane were added dropwise without cooling. The reaction mixture was stirred for 1.5 h at room temperature, and the resulting solid was then filtered off. The mother liquor was evaporated under reduced pressure at 30° C. until dry. The solids obtained in this way were combined and washed with 100 mL of isopropanol and with 3×100 mL of petroleum ether 40-60. The solid was dried under reduced pressure at 40° C. until a constant mass was achieved. The yield was 94% [(η³—C₃H₅)PdCl]₂ as a yellow solid.

¹H-NMR (400 MHz, CDCl₃): δ=3.04 (d, 4H), 4.11 (d, 4H), 5.46 (tt, 2H).

### Exemplary Embodiment 1b (Representation of η³-allylpalladium(II) Chloride Dimer, [(η³—C₃H₅)PdCl]₂)

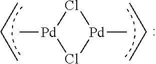

while stirring, 13.86 g of solid Na₂PdCl₄ were mixed with 47 mL of demineralized water and 47 mL of isopropanol. 5.64 g of allyltrimethylsilane were added dropwise under ice cooling. After the exothermic reaction had subsided, a further 1.34 g of allyltrimethylsilane was added dropwise without cooling. The reaction mixture was stirred for 1 h at room temperature and the resulting solid was then filtered off. The mother liquor was evaporated under reduced pressure at 30° C. until dry. The solids obtained in this way were combined and first washed with 2×25 ml of demineralized water, then with 25 mL of isopropanol and with 2×20 mL of petroleum ether 40-60. The solid was dried under reduced pressure at 40° C. until a constant mass was achieved. The yield was 89% [(η³—C₃H₅)PdCl]₂ as a yellow solid.

### Exemplary Embodiment 2 (Representation of (η³-1-phenylallyl)palladium(II) Chloride Dimer, [(η³—(C₆H₅)—C₃H₄)PdCl]₂

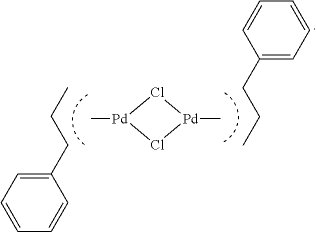

while stirring, 220 g of an aqueous H₂PdCl₄ solution with a Pd content of 20 wt. % were mixed with 220 mL of isopropanol. 80 g of cinnamyltrimethylsilane (E/Z mixture) were added dropwise under ice cooling. After the exothermic reaction had subsided, another 20 g of cinnamyltrimethylsilane were added dropwise without cooling. The reaction mixture was stirred for 1.5 h at room temperature, and the resulting solid was then filtered off. The mother liquor was evaporated under reduced pressure at 30° C. until dry. The solids obtained in this way were combined and washed with 2×100 mL of isopropanol and with 2×100 mL of petroleum ether 40-60. The solid was dried under reduced pressure at 40° C. until a constant mass was achieved. The yield was 95% [(η³—(C₆H₅)—C₃H₄)PdCl]₂ as a yellow solid.

¹H-NMR (400 MHz, CDCl₃): δ=3.04 (d, 2H), 3.96 (d, 2H), 4.63 (d, 2H), 5.80 (ddd, 2H), 7.24-7.30 (m, 4H), 7.31-7.38 (m, 2H), 7.47-7.52 (m, 4H).

### Exemplary Embodiment 3: Representation of (η³-1-methylallyl)palladium(II) Chloride Dimer, [η³—(CH₃)—C₃H₄)PdCl]₂

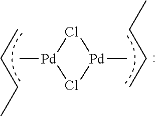

while stirring, 25 g of an aqueous H₂PdCl₄ solution with a Pd content of 20 wt. % were mixed with 25 mL of isopropanol. Under ice cooling, 6.4 g of crotyltrimethylsilane (E/Z mixture) were added dropwise. After the exothermic reaction had subsided, another 1.2 g of crotyltrimethylsilane were added dropwise without cooling. The reaction mixture was stirred for 30 minutes at room temperature, and the resulting solid was then filtered off. The mother liquor was evaporated under reduced pressure at 30° C. until dry. The solids obtained in this way were combined and washed with 2×20 mL of isopropanol and with 2×20 mL of petroleum ether 40-60. The solid was dried under reduced pressure at 40° C. until a constant mass was achieved. The yield was 93% [(η³—(CH₃)—C₃H₄)PdCl]₂ as a yellow solid.

¹H-NMR (400 MHz, CDCl₃): δ=1.32 (d, 6H), 2.81 (d, 2H), 3.85-3.94 (m, 4H), 5.28 (dt, 2H).

What is claimed is:

1. A method for preparing [(η³—CR1R2-CR3-CHR4)PdX]₂ by reaction of HₐNa_{b}K_{c}(NH₄)_{d}PdX₄ with CR1R2=CR3-CHR4-Si(R5)₃,
where a+b+c+d=2,
where H, Na, K and (NH₄) represent hydrogen, sodium, potassium and ammonium,
where X represents bromine (Br) or chlorine (Cl), wherein
(i) the substituent groups R1 and R2 are selected, independently of one another, from hydrogen (H), phenyl, methyl, ethyl, n-propyl, isopropyl and the isomeric non-cyclic butyl substituent groups, provided that the substituent groups R1 and R2 are not both phenyl, the substituent groups R3 and R4 are selected, independently of one another, from H, methyl, ethyl and n-propyl, and
the substituent groups R5 are methyl or ethyl,
or wherein
(ii) by means of one of the substituent groups R1 or R2, —CR1R2- together with —CR3- form adjacent ring members of a carbocyclic ring system bonded as a substituent to the —CHR4-carbon,
the substituent group R2 or R1 which is not involved in the formation of the carbocyclic ring system is selected from H, phenyl, methyl, ethyl, n-propyl, isopropyl and the isomeric non-cyclic butyl substituent groups,
the substituent group R4 is selected from H, methyl, ethyl and n-propyl, and
the substituent groups R5 are methyl or ethyl.

2. The method according to claim 1, comprising the steps of:
(1) providing HₐNa_{b}K_{c}(NH₄)_{d}PdX₄ and CR1R2=CR3-CHR4-Si(R5)₃, and
(2) bringing the two reactants provided in step (1), HₐNa_{b}K_{c}(NH₄)_{d}PdX₄ and CR1R2=CR3-CHR4-Si(R5)₃, into contact in a reaction vessel, and allowing them to react, forming [(η³—CR1R2-CR3-CHR4)PdX]₂, wherein at least one of the two reactants, HₐNa_{b}K_{c}(NH₄)_{d}PdX₄ and CR1R2=CR3-CHR4-Si(R5)₃, has previously been converted into a preparation containing at least one organic solvent and optionally water.

3. The method according to claim 2, wherein the at least one organic solvent is selected from alcohols having two to ten carbon atoms.

4. The method according to claim 1, where HₐNa_{b}K_{c}(NH₄)_{d}PdX₄ represents Na₂PdX₄ (b=2 and a=c=d=0), K₂PdX₄ (c=2 and a=b=d=0), (NH₄)₂PdX₄ (d=2 and a=b=c=0) or preferably H₂PdX₄ (a=2 and b=c=d=0).

5. The method according to claim 1, where the —CHR4 group is —CH₂—.

6. The method according to claim 1, where X represents chlorine (Cl).

7. The method according to claim 1, where R5 represents methyl.

8. The method according to claim 7, wherein CR1R2=CR3-CHR4-Si(R5)₃ is selected from the group consisting of the seven compounds

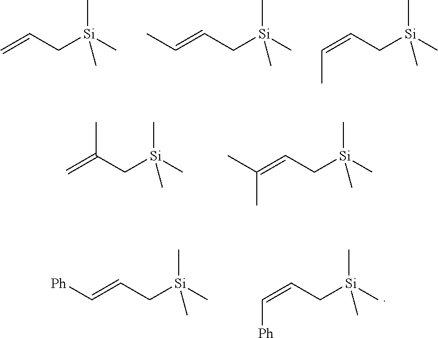

9. The method according to claim 8, where CR1R2=CR3-CHR4-Si(R5)₃ is allyltrimethylsilane.

10. The method according to claim 2, wherein measures are taken during the contacting of the two reactants to prevent a temperature of the reaction mixture that is forming or formed in the reaction vessel from rising above 50° C.

11. The method according to claim 2, wherein, after completion of the reaction, the corresponding reaction product formed [(η³—CR1R2-CR3-CHR4)PdX]₂ is separated as a solid by means of a solid-liquid separation process and the composition freed from the solid is concentrated or completely evaporated, obtaining further solid [(η³—CR1R2-CR3-CHR4)PdX]₂.

12. The method according to claim 1, wherein in the case that the corresponding reaction product formed [(η³—CR1R2-CR3-CHR4)PdX]₂ does not occur as a solid, the composition obtained after the end of the reaction is concentrated or completely evaporated, obtaining solid [(η³—CR1R2-CR3-CHR4)PdX]₂.

13. The method according to claim 2, where HₐNa_{b}K_{c}(NH₄)_{d}PdX₄ represents Na₂PdX₄ (b=2 and a=c=d=0), K₂PdX₄ (c=2 and a=b=d=0), (NH₄)₂PdX₄ (d=2 and a=b=c=0) or preferably H₂PdX₄ (a=2 and b=c=d=0).

14. The method according to claim 3, where HₐNa_{b}K_{c}(NH₄)_{d}PdX₄ represents Na₂PdX₄ (b=2 and a=c=d=0), K₂PdX₄ (c=2 and a=b=d=0), (NH₄)₂PdX₄ (d=2 and a=b=c=0) or preferably H₂PdX₄ (a=2 and b=c=d=0).

15. The method according to claim 2, where the —CHR4 group is —CH₂—.

16. The method according to claim 3, where the —CHR4 group is —CH₂—.

17. The method according to claim 4, where the —CHR4 group is —CH₂—.

18. The method according to claim 2, where X represents chlorine (Cl).

19. The method according to claim 3, where X represents chlorine (Cl).

20. The method according to claim 4, where X represents chlorine (Cl).
